(19) United States
(12) Patent Application Publication
(10) Pub. No.: US 2026/0370973 A1
(43) Pub. Date: Nov. 19, 2026

(54) SOLID-STATE IMAGING ELEMENT, PHOTODETECTION DEVICE, AND METHOD FOR MANUFACTURING SOLID-STATE IMAGING ELEMENT

(71) Applicant: Sony Semiconductor Solutions Corporation, Kanagawa (JP)

(72) Inventor: Kenichirou Anjyou, Kumamoto (JP)

(21) Appl. No.: 19/148,175

(22) PCT Filed: Jan. 9, 2024
(86) PCT No.: PCT/JP24/00159

§ 371 Date: Jul. 15, 2025

(30) Foreign Application Priority Data
Mar. 2, 2023 (JP) 2023-031940

(51) Int. Cl. H04N 25/77; H04N 25/532; H04N 25/771; H04N 25/778

(52) U.S. Cl. CPC H04N 25/77; H04N 25/532; H04N 25/771; H04N 25/778

(57) ABSTRACT

Variation in current is suppressed in a solid-state imaging element in which a transistor as a current source is respectively provided for individual pixels. In one example, a current source transistor, a capacitive element, and a sample-and-hold switch are provided in each pixel. The current source transistor has a source connected to a ground node and supplies a predetermined drain-source current. The capacitive element is inserted between the gate of the current source transistor and the ground node. The sample-and-hold switch samples and holds a predetermined bias voltage in the capacitive element within a period in which the drain-source current is not supplied.

### TECHNICAL FIELD

The present technology relates to a solid-state imaging element. More specifically, the present technology relates to a solid-state imaging element provided with a transistor as a current source, a photodetection device, and a method for manufacturing the solid-state imaging element.

### BACKGROUND ART

Conventionally, in a CMOS image sensor (CIS), a global shutter method of simultaneously exposing all pixels is used for the purpose of suppressing rolling shutter distortion. For example, a solid-state imaging element has been proposed in which a capacitive element is provided for each pixel and a voltage is sampled and held in the capacitive element (See, for example, Non-Patent Document 1.). In the solid-state imaging element, as a current source, for each pixel, an n-channel metal oxide semiconductor (nMOS) transistor is disposed in which the source is grounded and a bias voltage is applied to the gate.

### CITATION LIST

### Patent Document

Patent Document 1: Geunsook Park, et al., A 2.2 μm stacked back side illuminated voltage domain global shutter CMOS image sensor, IEDM 2019.

### SUMMARY OF THE INVENTION

### Problems to be Solved by the Invention

In the above-described conventional technology, a capacitive element is provided for each pixel to sample and hold a voltage, whereby the global shutter method is implemented. However, in the above-described solid-state imaging element, the gate-source voltage of the nMOS transistor as the current source may vary for each pixel due to factors such as ground bounce when the pixel is driven. As a result, there is a problem that a current flowing through the nMOS transistor as the current source varies for each pixel.

The present technology has been made in view of such a situation, and an object thereof is to suppress variation in current in a solid-state imaging element in which a transistor as a current source is provided for each pixel.

### Solutions to Problems

The present technology has been made to solve the above-described problem, and a first aspect thereof is a solid-state imaging element including a plurality of pixels each provided with: a current source transistor whose source is connected to a ground node and that supplies a predetermined drain-source current; a capacitive element inserted between a gate of the current source transistor and the ground node; and a sample-and-hold switch configured to sample and hold a predetermined bias voltage in the capacitive element within a period in which the drain-source current is not supplied, and a method for controlling the solid-state imaging element. This brings about an effect of suppressing variation in current.

Furthermore, in the first aspect, there may be further included: an amplification transistor that amplifies a voltage of a floating diffusion layer and outputs the voltage amplified from a source; and a switch circuit that opens and closes a path between the amplification transistor and the current source transistor, in which the sample-and-hold switch may sample and hold the bias voltage in the capacitive element within a period in which the switch circuit is in an open state. This brings about an effect of holding the bias voltage.

Furthermore, in the first aspect, there may be further included a sample-and-hold circuit that holds each of a signal level corresponding to an amount of exposure and a predetermined reset level. This brings about an effect of implementing the global shutter.

Furthermore, in the first aspect, the switch circuit may include at least one of: a switch transistor that opens and closes a path between the source of the amplification transistor and a pre-stage node connected to the sample-and-hold circuit; or a precharge transistor that opens and closes a path between the pre-stage node and a drain of the current source transistor. This brings about an effect of cutting off the current by control of the transistor.

Furthermore, in the first aspect, there may be further included a mirror source transistor through which a predetermined reference current flows, in which the sample-and-hold switch may open and close a path between a gate and a drain of the mirror source transistor and the gate of the current source transistor. This brings about an effect of supplying a current corresponding to the reference current.

Furthermore, in the first aspect, the current source transistor, the capacitive element, and the sample-and-hold switch may be disposed on any of a plurality of semiconductor chips stacked. This brings about an effect of facilitating pixel miniaturization.

Furthermore, in the first aspect, each of the plurality of pixels may detect presence or absence of an address event. This brings about an effect of suppressing variation in current of the pixel that detects the address event.

Furthermore, a second aspect of the present technology is a photodetection device including: a pixel of a plurality of pixels each provided with a current source transistor whose source is connected to a ground node and that supplies a predetermined drain-source current, a capacitive element inserted between a gate of the current source transistor and the ground node, and a sample-and-hold switch configured to sample and hold a predetermined bias voltage in the capacitive element within a period in which the drain-source current is not supplied; and a signal processing circuit that processes a pixel signal from each of the plurality of pixels. This brings about an effect of reducing power consumption by suppression of variation in current.

### BRIEF DESCRIPTION OF DRAWINGS

FIG. 1 is a block diagram illustrating a configuration example of an imaging device according to a first embodiment of the present technology.

FIG. 2 is a block diagram illustrating a configuration example of a solid-state imaging element according to the first embodiment of the present technology.

FIG. 3 is a circuit diagram illustrating a configuration example of a pixel according to the first embodiment of the present technology.

FIG. 4 is a circuit diagram illustrating a configuration example of an accessory according to the first embodiment of the present technology.

FIG. 5 is a block diagram illustrating a configuration example of a load metal oxide semiconductor (MOS) circuit block and a column signal processing circuit according to the first embodiment of the present technology.

FIG. 6 is a timing chart illustrating an example of operation of the solid-state imaging element according to the first embodiment of the present technology.

FIG. 7 is a graph illustrating an example of characteristics of a current source transistor according to the first embodiment of the present technology.

FIG. 8 is a circuit diagram illustrating an example of a state of a solid-state imaging element in a comparative example.

FIG. 9 is a diagram illustrating an example of a state of the solid-state imaging element at the time of sample and hold according to the first embodiment of the present technology.

FIG. 10 is a diagram illustrating an example of a state of the solid-state imaging element after sample and hold by the pixel according to the first embodiment of the present technology.

FIG. 11 is a diagram illustrating an example of a layout of a sample-and-hold switch, a capacitive element, and the current source transistor according to the first embodiment of the present technology.

FIG. 12 is a flowchart illustrating an example of operation of the solid-state imaging element according to the first embodiment of the present technology.

FIG. 13 is a circuit diagram illustrating a configuration example of the pixel according to a first modification example of the first embodiment of the present technology.

FIG. 14 is a circuit diagram illustrating another example of the pixel according to the first modification example of the first embodiment of the present technology.

FIG. 15 is a circuit diagram illustrating a configuration example of the pixel in which the number of transistors is reduced according to the first modification example of the first embodiment of the present technology.

FIG. 16 is a diagram illustrating an example of a stacked structure of the solid-state imaging element according to a second embodiment of the present technology.

FIG. 17 is a circuit diagram illustrating a configuration example of the pixel according to the second embodiment of the present technology.

FIG. 18 is a block diagram illustrating a configuration example of the solid-state imaging element according to a third embodiment of the present technology.

FIG. 19 is a circuit diagram illustrating a configuration example of a pixel according to the third embodiment of the present technology.

FIG. 20 is a block diagram illustrating a schematic configuration example of a vehicle control system.

FIG. 21 is an explanatory diagram illustrating an example of an installation position of an imaging section.

### MODE FOR CARRYING OUT THE INVENTION

Modes for carrying out the present technology (hereinafter, referred to as embodiments) will be described below. The description will be given in the following order.
1. First Embodiment (example of sampling and holding in capacitive element while current is stopped)
2. Second Embodiment (example of sampling and holding in capacitive element while current is stopped in stacked structure)
3. Third Embodiment (example of sampling and holding in capacitive element while current is stopped and detecting address event)
4. Example of Application to Mobile Body

### 1. First Embodiment

### Configuration Example of Imaging Device

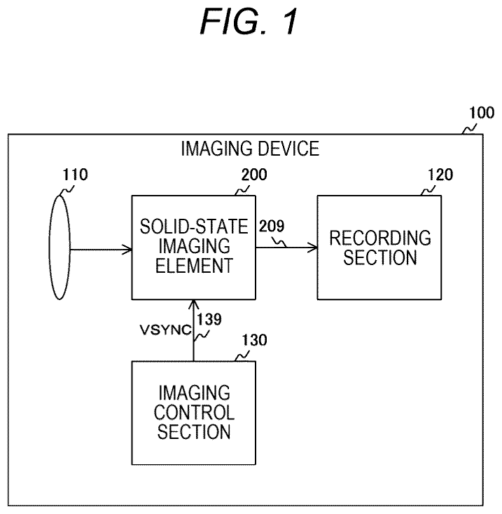

FIG. 1 is a block diagram illustrating a configuration example of an imaging device 100 in a first embodiment of the present technology. The imaging device 100 is a device that captures image data, and includes an imaging lens 110, a solid-state imaging element 200, a recording section 120, and an imaging control section 130. As the imaging device 100, a digital camera or an electronic device (a smartphone, a personal computer, or the like) having an imaging function is assumed. Note that the imaging device 100 is an example of a photodetection device described in claims.

The solid-state imaging element 200 captures image data under control of the imaging control section 130. The solid-state imaging element 200 supplies the image data to the recording section 120 via a signal line 209.

The imaging lens 110 condenses light and guides the light to the solid-state imaging element 200. The imaging control section 130 controls the solid-state imaging element 200 to capture the image data. For example, the imaging control section 130 supplies an imaging control signal including a vertical synchronization signal VSYNC to the solid-state imaging element 200 via a signal line 139. The recording section 120 records the image data.

Here, the vertical synchronization signal VSYNC is a signal indicating imaging timing, and a periodic signal of a constant frequency (such as 60 Hertz) is used as the vertical synchronization signal VSYNC.

Note that although the imaging device 100 records the image data, the image data may be transmitted to the outside of the imaging device 100. In this case, an external interface for transmitting the image data is further provided. Alternatively, the imaging device 100 may further display the image data. In this case, a display section is further provided.

### Configuration Example of Solid-State Imaging Element

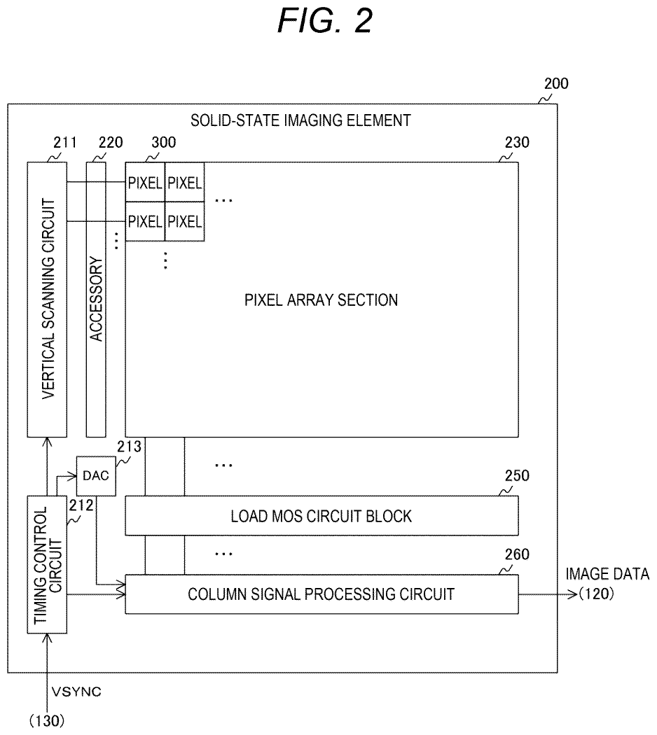

FIG. 2 is a block diagram illustrating a configuration example of the solid-state imaging element 200 according to the first embodiment of the present technology. The solid-state imaging element 200 is a CIS, and includes a vertical scanning circuit 211, an accessory 220, and a pixel array section 230. Moreover, the solid-state imaging element 200 includes a timing control circuit 212, a digital to analog converter (DAC) 213, a load MOS circuit block 250, and a column signal processing circuit 260. In the pixel array section 230, a plurality of pixels 300 is arranged in a two-dimensional grid pattern. Furthermore, each circuit in the solid-state imaging element 200 is provided in, for example, a single semiconductor chip.

Hereinafter, a set of the pixels 300 arranged in a horizontal direction will be referred to as “row”, and a set of the pixels 300 arranged in a direction orthogonal to the row will be referred to as “column”.

The timing control circuit 212 controls operation timing of each of the vertical scanning circuit 211, the DAC 213, and the column signal processing circuit 260 in synchronization with the vertical synchronization signal VSYNC from the imaging control section 130.

The DAC 213 generates a sawtooth-shaped ramp signal by digital to analog (DA) conversion. The DAC 213 supplies the generated ramp signal to the column signal processing circuit 260.

The vertical scanning circuit 211 sequentially selects and drives rows to cause an analog pixel signal to be output. Each of the pixels 300 photoelectrically converts incident light to generate an analog pixel signal. The pixel 300 supplies the pixel signal to the column signal processing circuit 260 via the load MOS circuit block 250.

In the accessory 220, a mirror source transistor is disposed constituting a current mirror circuit with a current source transistor (not illustrated) in the pixel.

In the load MOS circuit block 250, a MOS transistor that supplies a constant current is provided for each column.

The column signal processing circuit 260 executes signal processing such as analog to digital (AD) conversion processing and correlated double sampling (CDS) processing on the pixel signal for each column. The column signal processing circuit 260 supplies the image data including the processed signals to the recording section 120. Note that the column signal processing circuit 260 is an example of a signal processing circuit described in the claims.

### Configuration Example of Pixel

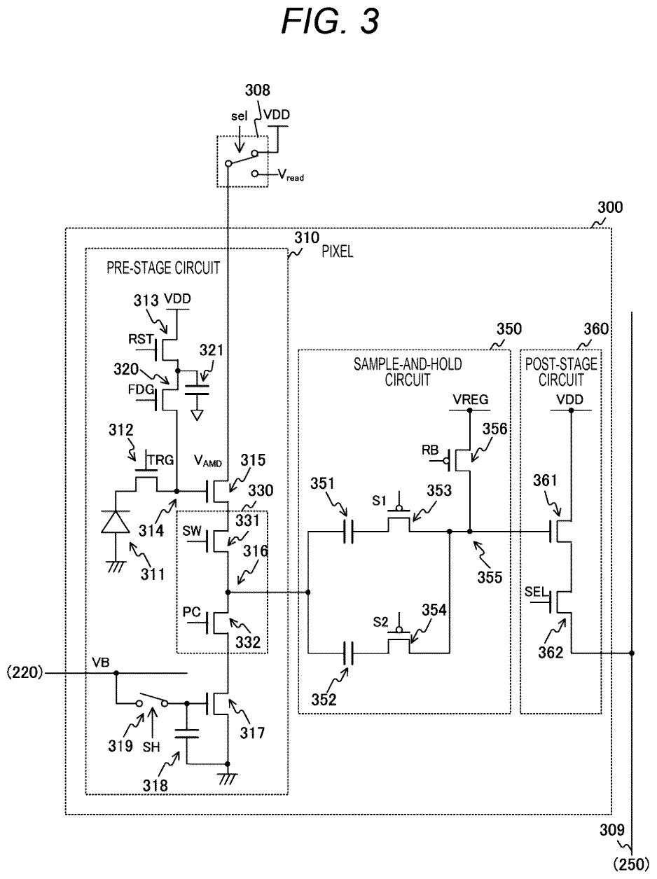

FIG. 3 is a circuit diagram illustrating a configuration example of the pixel 300 according to the first embodiment of the present technology. The pixel 300 includes a pre-stage circuit 310, a sample-and-hold circuit 350, and a post-stage circuit 360. The pre-stage circuit 310 includes a photoelectric conversion element 311, a transfer transistor 312, a pre-stage reset transistor 313, a floating diffusion (FD) 314, and a pre-stage amplification transistor 315. Moreover, the pre-stage circuit 310 includes a switch circuit 330, a current source transistor 317, a capacitive element 318, and a sample-and-hold switch 319. The switch circuit 330 includes a switch transistor 331. Furthermore, the pixel 300 further includes a conversion efficiency control transistor 320, a capacitive element 321, and a precharge transistor 332. Furthermore, a selector 308 is added for each column. As the transistors in the pre-stage circuit 310, for example, nMOS transistors are used.

The photoelectric conversion element 311 photoelectrically converts incident light to generate charges. The transfer transistor 312 transfers the charges from the photoelectric conversion element 311 to the FD 314 in accordance with a transfer signal TRG from the vertical scanning circuit 211. The pre-stage reset transistor 313 initializes the FD 314 in accordance with a reset signal RST from the vertical scanning circuit 211.

The FD 314 accumulates charges, and generates a voltage corresponding to an amount of the charges. Hereinafter, a voltage when the FD 314 is initialized is referred to as a “reset level”, and a voltage when the charges are transferred to the ED 314 is referred to as a “signal level”.

The pre-stage amplification transistor 315 amplifies the voltage of the FD 314 and outputs the amplified voltage from the source. Note that the pre-stage amplification transistor 315 is an example of an amplification transistor described in the claims.

The switch transistor 331 opens and closes a path between the source of the pre-stage amplification transistor 315 and the drain of the current source transistor 317 in accordance with a control signal SW from the vertical scanning circuit 211. A connection node between the switch transistor 331 and the current source transistor 317 is referred to as a pre-stage node 316.

The current source transistor 317 supplies a constant drain-source current I_{ds} according to a voltage applied to the gate. Furthermore, the source of the current source transistor 317 is connected to a ground node.

The capacitive element 318 is inserted between the gate and the source (in other words, the ground node) of the current source transistor 317. The sample-and-hold switch 319 opens and closes a path between the accessory 220 and the gate of the current source transistor 317 in accordance with a control signal SH from the vertical scanning circuit 211.

Here, a configuration in which the capacitive element 318 and the sample-and-hold switch 319 are not disposed is assumed as a comparative example.

In the comparative example, it is assumed that the vertical scanning circuit 211 turns on the switch transistors 331 of all the pixels by the control signal SW at the end of exposure. As a result, the drain-source current I_{ds} flows through the current source transistors 317 of all the pixels. At this time, a gate-source voltage V_{gs} of the current source transistor 317 may vary for each pixel. The variation in the gate-source voltage V_{gs} is caused by the following two factors.

The first is ground bounce on the pixel side caused by IR drop by a DC current itself in the pixel. Although resistance of a ground power network is reduced as much as possible by mesh wiring or the like, bounce of about several tens of millivolts (mV) is inevitable.

The second is variation in a bias voltage VB due to ground bounce on the accessory 220 side. However, regarding the second, since the accessory 220 is disposed outside the pixel array section 230, it is easy to take measures against the ground bounce. For this reason, influence of the first factor is larger.

Thus, the capacitive element 318 and the sample-and-hold switch 319 are disposed, and in a period in which the switch transistor 331 is in the off state, the vertical scanning circuit 211 shifts the sample-and-hold switch 319 from the closed state to the open state by the control signal SH. As a result, the bias voltage VB is sampled and held in the capacitive element 318.

Thereafter, when the switch transistor 331 transitions to the on state, the ground bounce occurs; however, since the sample-and-hold switch 319 is in the open state, there is no place to escape for charges on the voltage side of the capacitive element 318, and the voltage rises by an amount of the ground bounce. As a result, it is possible to suppress fluctuation of a potential difference (that is, the gate-source voltage V_{gs}) between both ends of the capacitive element 318. As a result, fluctuation of the drain-source current I_{ds} for each pixel is suppressed.

Assuming that a capacitance value of a parasitic capacitance is Cp and a capacitance value of the capacitive element 318 is Cs, a fluctuation ΔV_{gs} of the gate-source voltage V_{gs} with respect to the ground bounce is expressed by, for example, the following expression.

ΔV_{gs}∝Cs/(Cp+Cs) Expression 1

For example, assuming that Cp is about 1 femtofarad (fF), Cs is only required to be about 10 femtofarad (fF) from the above expression in order to reduce ΔV_{gs} by 90%. With a capacitance value of this level, it is possible to appropriately balance an area of the capacitive element 318 and followability of a potential on a power supply side with respect to the bounce.

The sample-and-hold circuit 350 holds each of a signal level corresponding to an amount of exposure and a predetermined reset level. The sample-and-hold circuit 350 includes capacitive elements 351 and 352, selection transistors 353 and 354, and post-stage reset transistor 355. As the transistors in the sample-and-hold circuit 350, for example, nMOS transistors are used.

The capacitive elements 351 and 352 hold a voltage (reset level or signal level) output from the pre-stage circuit 310. For example, the capacitive element 351 holds the reset level, and the capacitive element 352 holds the signal level. As such capacitive elements, for example, an element having a metal insulator metal (MIM) structure is used. Furthermore, one end of each of the capacitive elements 351 and 352 is commonly connected to the pre-stage node 316.

The selection transistor 353 opens and closes a path between the other end of the capacitive element 351 and a post-stage node 356 in accordance with a selection signal S1 from the vertical scanning circuit 211. The selection transistor 354 opens and closes a path between the other end of the capacitive element 352 and the post-stage node 356 in accordance with a selection signal S2 from the vertical scanning circuit 211.

The post-stage reset transistor 355 initializes a voltage of the post-stage node 356 to a predetermined potential VREG in accordance with a post-stage reset signal RB from the vertical scanning circuit 211. A potential different from a power supply voltage VDD (for example, a potential lower than VDD) is set as the potential VREG.

The post-stage circuit 360 includes a post-stage amplification transistor 361, and a post-stage selection transistor 362. As the transistors, for example, nMOS transistors are used.

The post-stage amplification transistor 361 amplifies a voltage of the post-stage node 356. The post-stage selection transistor 362 outputs a signal of a voltage amplified by the post-stage amplification transistor 361 to a vertical signal line 309 as a pixel signal in accordance with a selection signal SEL from the vertical scanning circuit 211.

The conversion efficiency control transistor 320 controls conversion efficiency of converting the charges into a voltage in accordance with a control signal FDG from the vertical scanning circuit 211. In a case where the conversion efficiency control transistor 320 is in the on state, the capacitive element 321 is connected to the FD 314, and the conversion efficiency decreases. On the other hand, in a case where the conversion efficiency control transistor 320 is in the off state, the charges are converted into a voltage only by the FD 314, and the conversion efficiency increases. As the capacitive elements 321, for example, an element having the MIM structure is used.

The selector 308 selects either the power supply voltage VDD or a voltage Vread in accordance with a selection signal sel from the vertical scanning circuit 211 and supplies the selected voltage to the drain of the pre-stage amplification transistor 315 as a drain voltage VAMD. When the sample-and-hold circuit 350 samples and holds a voltage, the power supply voltage VDD is selected. On the other hand, the voltage Vread is selected when a voltage is read from the sample-and-hold circuit 350 and AD conversion is performed for each row.

Here, the voltage Vread is set to a value shown in the following expression.

Vread=VDD−Vgs−Vft Expression 2

In the above expression, Vgs represents a gate-source voltage of the pre-stage amplification transistor 315. Vft is an amount of fluctuation of a potential of the FD 314 due to reset feed through of the pre-stage reset transistor 313.

By switching to the voltage Vread at the time of reading, the pre-stage amplification transistor 315 is turned off, and noise generated in the transistor can be reduced.

The precharge transistor 332 is disposed in the switch circuit 330, and opens and closes a path between the pre-stage node 316 and the current source transistor 317 in accordance with a control signal PC from the vertical scanning circuit 211.

Note that, although both the switch transistor 331 and the precharge transistor 332 are disposed in the switch circuit 330, it is also possible to dispose only one of them.

The sample-and-hold switch 319 samples and holds the bias voltage VB within a period in which at least one of the two transistors in the switch circuit 330 is in the off state.

Furthermore, in the sample-and-hold circuit 350, p-channel metal oxide semiconductor (pMOS) transistors are used as the selection transistor 353, the selection transistor 354, and the post-stage reset transistor 355.

Furthermore, the vertical scanning circuit 211 can control the transfer signal TRG, the reset signal RST, and the control signal FDG to any of a high level, a middle level, and a low level. The high level is set to a value higher than “0” volt (V). The middle level is set lower than the high level, for example, to “0” volt (V). The low level is set lower than the middle level, for example, to “−1” volt (V). That is, the transfer transistor 312, the pre-stage reset transistor 313, and the conversion efficiency control transistor 320 corresponding to these signals are driven with three values.

When causing the capacitive element 351 to hold the reset level, the vertical scanning circuit 211 can soft reset the pre-stage amplification transistor 315 by changing the transfer signal TRG, the reset signal RST, and the control signal FDG from the middle level to the low level. As a result, kTC noise is reduced.

Furthermore, by using a pMOS as the transistor in the sample-and-hold circuit 350, it is possible to reduce charge loss from the capacitive element 351 when a gate voltage of the pre-stage amplification transistor 315 is returned from the low level to the middle level.

Note that, although all of the conversion efficiency control transistor 320, the capacitive element 321, the selector 308, and the precharge transistor 332 are disposed, not limited to this configuration, some of them can be reduced. Furthermore, although the vertical scanning circuit 211 drives some transistors with three values, in a case where it is not necessary to perform soft reset, these transistors can also be driven with two values. Furthermore, although three pMOS transistors are disposed in the sample-and-hold circuit 350, it is also possible to use nMOS transistors as some or all of them.

### Configuration Example of Accessory

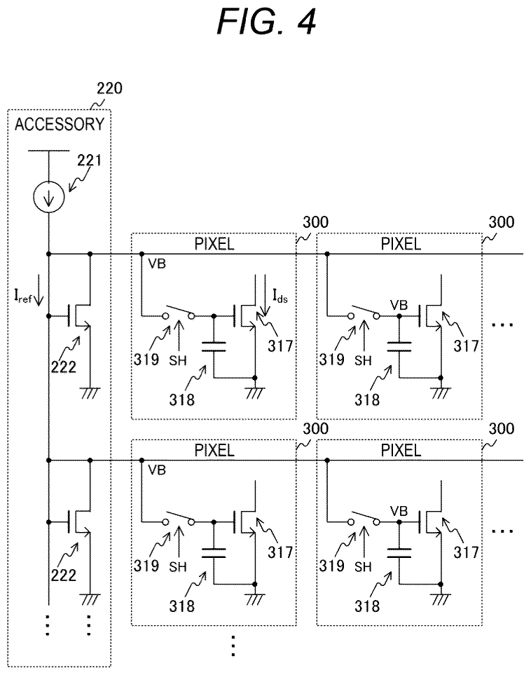

FIG. 4 is a circuit diagram illustrating a configuration example of the accessory 220 according to the first embodiment of the present technology. The accessory 220 includes a reference current source 221 and a plurality of mirror source transistors 222. When the mirror source transistors 222 are disposed for respective rows, and the number of rows is N (N is an integer), the number of mirror source transistors 222 is N. As the mirror source transistors 222, for example, nMOS transistors are used.

The reference current source 221 supplies a predetermined reference current I_{ref}. The gate and the drain of each mirror source transistor 222 are connected to the reference current source 221, and the source is connected to the ground node. Furthermore, the sample-and-hold switch 319 opens and closes a path between the gate and the drain of the mirror source transistor 222 of the corresponding row and the gate of the current source transistor 317. Note that, in the drawing, elements other than the current source transistor 317, the capacitive element 318, and the sample-and-hold switch 319 are omitted in each of the pixels 300.

With the above-described circuit configuration, in a case where the sample-and-hold switch 319 is in the closed state, the mirror source transistor 222 and the Corresponding current source transistor 317 constitute a current mirror circuit. If the switch transistor 331 (not illustrated) is in the on state when the sample-and-hold switch 319 is in the closed state, the drain-source current I_{ds} according to the reference current I_{ref} flows through the current source transistor 317.

In order to suppress the influence of the ground bounce, the vertical scanning circuit 211 shifts the sample-and-hold switch 319 from the on state to the off state by the control signal SH within the period in which the switch transistor 331 is in the off state. As a result, a voltage of the gate of the mirror source transistor 222 is sampled and held in the capacitive element 318 as the bias voltage VB.

After the sample and hold, the vertical scanning circuit 211 turns on the switch transistor 331. At this time, since the bias voltage VB is held in the capacitive element 318, the drain-source current I_{ds} according to the reference current I_{ref} of the mirror source flows through the current source transistor 317.

### Configuration Example of Column Signal Processing Circuit

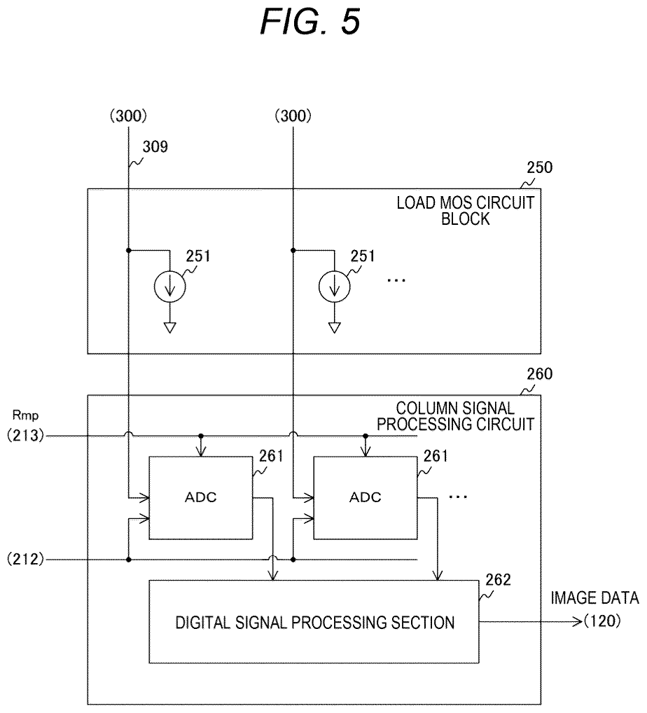

FIG. 5 is a block diagram illustrating a configuration example of the load MOS circuit block 250 and the column signal processing circuit 260 according to the first embodiment of the present technology.

In the load MOS circuit block 250, the vertical signal line 309 is wired for each column. When the number of columns is I (I is an integer), I vertical signal lines 309 are wired. Furthermore, a load MOS transistor 251 that supplies a constant current is connected to each of the vertical signal lines 309.

In the column signal processing circuit 260, a plurality of analog to digital converters (ADCs) 261 and a digital signal processing section 262 are disposed. The ADC 261 is disposed for each column. When the number of columns is I, I ADCs 261 are disposed.

The ADC 261 converts an analog pixel signal from the corresponding column into a digital signal using a ramp signal Rmp from the DAC 213. The ADC 261 supplies the digital signal to the digital signal processing section 262. For example, a single-slope ADC including a comparator and a counter is disposed as the ADC 261.

The digital signal processing section 262 performs predetermined signal processing such as CDS processing on each of digital signals for respective columns. The digital signal processing section 262 supplies image data including the processed digital signals to the recording section 120.

### Operation Example of Solid-State Imaging Element

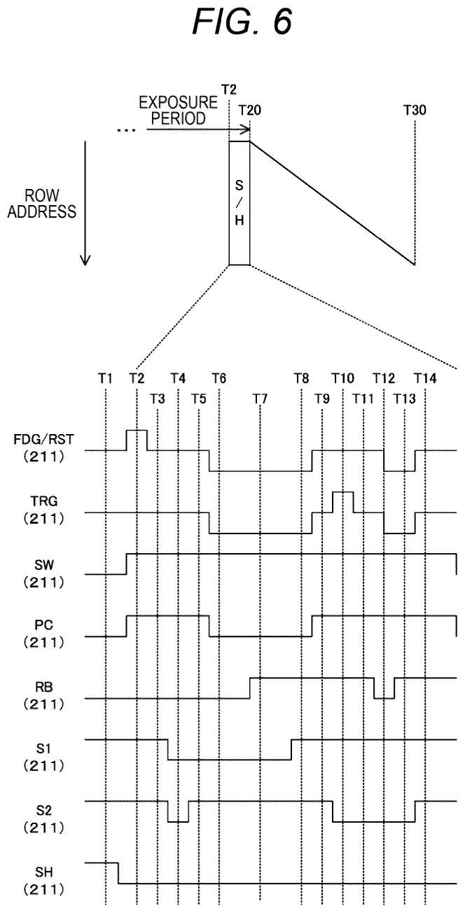

FIG. 6 is a timing chart illustrating an example of operation of the solid-state imaging element 200 according to the first embodiment of the present technology. The vertical scanning circuit 211 drives all the pixels to cause them to simultaneously start exposure. That is, exposure is performed by a global shutter method. In a sample and hold period from timing T2 to timing T20 at the end of an exposure period, the vertical scanning circuit 211 drives all the pixels to cause voltages (reset level and signal level) to be held. Then, in a read period from timing T20 to timing T30, the vertical scanning circuit 211 sequentially drives the rows to cause voltage reading and analog to digital (AD) conversion to be executed.

In a period before timing T2, the control signal SW is at the low level, and the control signal SH is at the high level. At timing T1 within the period, the vertical scanning circuit 211 changes the control signal SH from the high level to the low level. As a result, the bias voltage is sampled and held in the capacitive element 318 in the pixel.

At timing T2, the vertical scanning circuit 211 sets the control signal FDG, the reset signal RST, the control signal SW, and the control signal PC to the high level. As a result, the FD 314 and the post-stage node are initialized.

At timing T3, the vertical scanning circuit 211 sets the control signal FDG and the reset signal RST to the middle level. As a result, a state of the reset level is determined, and the pre-stage node is in a potential state buffered by the pre-stage amplification transistor 315.

The vertical scanning circuit 211 sets the selection signals S1 and S2 to the low level at timing T4, and sets the selection signal S2 to the high level at timing T5 immediately after that. As a result, the reset level is sampled in the capacitive element 351.

Then, at timing T6, the vertical scanning circuit 211 changes the transfer signal TRG, the reset signal RST, and the control signal FDG from the middle level to the low level, and changes the control signal PC from the high level to the low level. As a result, the voltage of the FD 314 (the gate of the pre-stage amplification transistor 315) drops, the pre-stage amplification transistor 315 is soft reset, and the reset level is held in the capacitive element 351.

At timing T7, the vertical scanning circuit 211 sets the post-stage reset signal RB to the high level. As a result, the post-stage reset transistor 355 on the right side of the capacitive element 351 is also turned off.

At timing T8, the vertical scanning circuit 211 sets the selection signal S1 to the high level. As a result, the selection transistor 353 is also turned off.

At timing T9, the vertical scanning circuit 211 returns the transfer signal TRG, the reset signal RST, and the control signal FDG to the middle level, and returns the control signal PC to the high level. As a result, charges lost at the timing T6 can be recovered, and the loss of the reset level information can be prevented.

At timing T10, the vertical scanning circuit 211 sets the transfer signal TRG to the high level and sets the selection signal S2 to the low level. As a result, charges are transferred to the FD 314. At timing T11, the vertical scanning circuit 211 sets the transfer signal TRG to the middle level. As a result, the signal level is sampled in the capacitive element 352.

At timing T12, the vertical scanning circuit 211 sets the post-stage reset signal RB to the low level, and immediately thereafter, sets the transfer signal TRG, the reset signal RST, and the control signal FDG to the low level. At timing T13, the vertical scanning circuit 211 returns the post-stage reset signal RB to the high level. As a result, the post-stage node is initialized.

At timing T14, the vertical scanning circuit 211 sets the selection signal S2 to the high level, and returns the transfer signal TRG, the reset signal RST, and the control signal FDG to the middle level. As a result, the selection transistor 354 is turned off, and the signal level is held in the capacitive element 352.

In the subsequent read period, the control signal SW is controlled to the middle level. Furthermore, the selection signals S1 and S2 are sequentially controlled to the high level, and the reset level and the signal level are sequentially read.

Note that the vertical scanning circuit 211 keeps the switch transistor 331 in the on state within the sample and hold period, but the control is not limited to this. For example, it is also possible for the vertical scanning circuit 211 to alternately turn on and off the switch transistor 331 and the precharge transistor 332 within the sample and hold period. As a result, settling of the pre-stage node from the high level to the low level can be accelerated to improve responsiveness.

As illustrated in the drawing, the control signal SH is controlled from the high level to the low level in a period in which the control signal SW is at the low level and the drain-source current I_{ds} is not supplied. As a result, the bias voltage is sampled and held in the capacitive element 318 in the pixel.

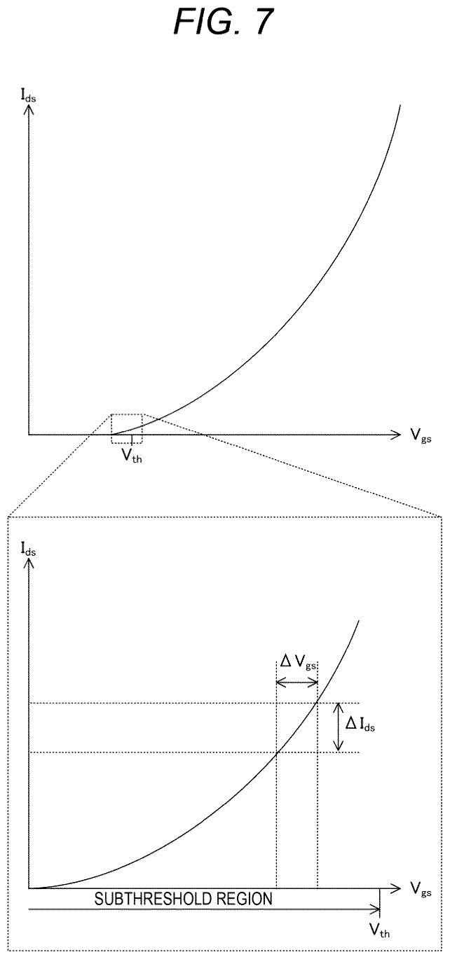

FIG. 7 is a graph illustrating an example of characteristics of the current source transistor 317 according to the first embodiment of the present technology. In the drawing, the vertical axis represents the drain-source current I_{ds} of the current source transistor 317, and the horizontal axis represents the gate-source voltage V_{gs}.

In a case where the current source transistor 317 is disposed for each pixel, from a viewpoint of suppressing power consumption, a current value per pixel has to be several nanoamperes (NA), and inevitably is a current in a weak inversion region (in other words, a subthreshold region) less than a threshold voltage Vₜₕ. In the weak inversion region, the drain-source current I_{ds} is expressed by the following expression.

I_{ds}=I₀·exp{(V_{gs}−Vₜₕ)/ηV_{T}} Expression 3

In the above expression, I₀ and η are coefficients, and V_{T} is a thermal voltage.

From Expression 3, in the weak inversion region, the drain-source current I_{ds} is a power of a natural logarithm with a value corresponding to the gate-source voltage V_{gs} as a power exponent. As described above, a variation ΔI_{ds} of the drain-source current I_{ds} caused by the variation ΔV_{gs} of the gate-source voltage V_{gs} is extremely large as compared with a case where the same degree of ΔV_{gs} is generated in a strong inversion region.

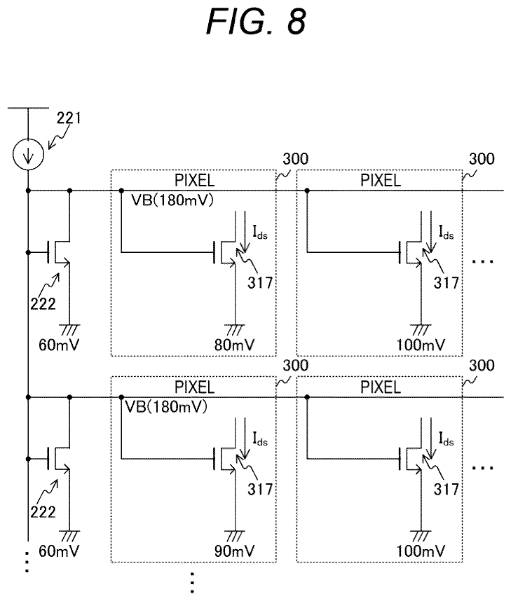

FIG. 8 is a circuit diagram illustrating an example of a state of the solid-state imaging element 200 in the comparative example. In the comparative example, the capacitive element 318 and the sample-and-hold switch 319 are not provided in each of the pixels 300, and the gate and the source of the mirror source transistor 222 are directly connected to the gate of the current source transistor 317 as a mirror destination.

In the comparative example, when all the pixels are driven and the drain-source current I_{ds} flows, ground bounce occurs due to the current, and a ground voltage varies for each pixel. For example, the ground voltage is 80 millivolts (mV) in the upper left pixel in the drawing, but the ground voltage is 100 millivolts (mV) in the upper right pixel.

Note that, although the bias voltage VB may vary due to the ground bounce on the accessory side, it is assumed that there is no variation in the bias voltage VB for convenience of description.

In the comparative example, the gate-source voltage of the current source transistor 317 varies due to the variation in the ground voltage for each pixel. For example, in the upper left pixel, since the bias voltage VB is 180 millivolts (mV) and the ground voltage is 80 millivolts (mB), the gate-source voltage is 100 millivolts (mV). On the other hand, in the upper right pixel, since the bias voltage VB is 180 millivolts (mV) and the ground voltage is 100 millivolts (mB), the gate-source voltage is 80 millivolts (mV). Due to the variation in the gate-source voltage, the drain-source current I_{ds} of the current source transistor 317 varies for each pixel.

In the comparative example illustrated in the drawing, it is necessary to supply a sufficiently large reference current I_{ref} so that a current value necessary for driving can be obtained in all the pixels even if the drain-source current I_{ds} varies.

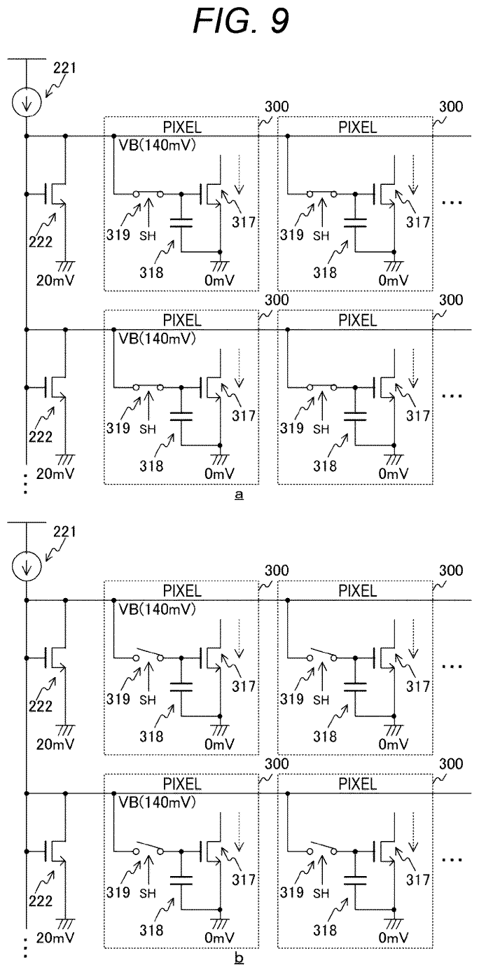

FIG. 9 is a diagram illustrating an example of a state of the solid-state imaging element at the time of sample and hold by the pixel according to the first embodiment of the present technology. In the drawing, a illustrates a state of the solid-state imaging element at the time of sampling by the sample-and-hold switch 319, and b in the drawing illustrates a state at the time of holding.

As illustrated in a in the drawing, it is assumed that the supply of the drain-source current Ids of the current source transistor 317 is stopped with the switch transistor 331 (not illustrated) in the off state in all the pixels. Dotted arrows mean stop of the supply of the drain-source current Ids. In this period, no ground bounce occurs for each pixel, and the ground voltages of all the pixels are, for example, 0 millivolts (mV).

Note that, although the bias voltage VB may vary due to the ground bounce on the accessory side, it is assumed that there is no variation in the bias voltage VB for convenience of description.

The vertical scanning circuit 211 closes the sample-and-hold switches 319 of all the pixels. As a result, the bias voltage VB is sampled in the capacitive element 318.

Then, as illustrated in b in the drawing, the vertical scanning circuit 211 closes the sample-and-hold switches 319 of all the pixels within the period in which the switch transistor 331 is in the off state. As a result, the bias voltage VB of the capacitive element 318 is held.

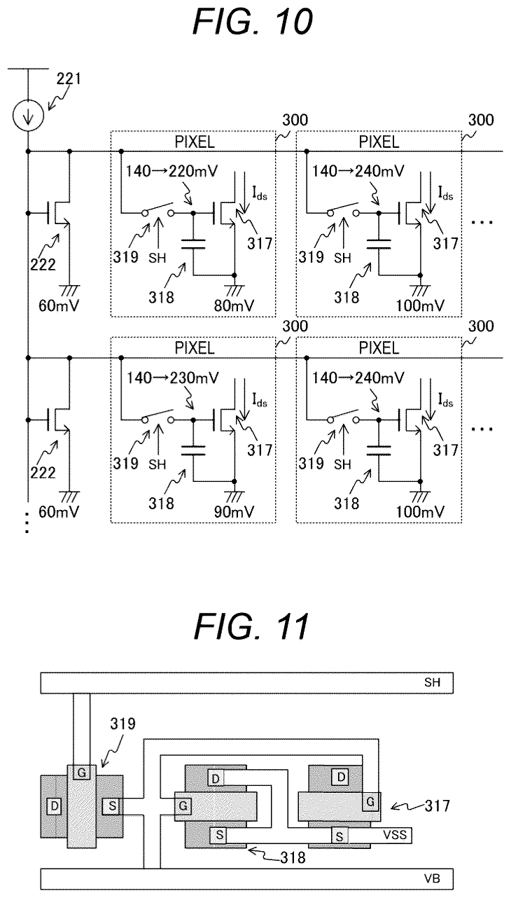

Subsequently, as illustrated in FIG. 10, the vertical scanning circuit 211 turns on the switch transistors 331 (not illustrated) of all the pixels, and causes the drain-source current I_{ds} to flow. The current causes ground bounce, and the ground voltage varies for each pixel. For example, the ground voltage is 80 millivolts (mV) in the upper left pixel in the drawing, but the ground voltage is 100 millivolts (mV) in the upper right pixel.

At this time, since the sample-and-hold switch 319 is in the open state, there is no place to escape for charges on the voltage side of the capacitive element 318. For this reason, according to a formula of Q=CV, the voltage rises by the amount of the ground bounce on the voltage side of the capacitive element 318. For example, in the upper left pixel, the voltage on the power supply side rises from 140 millivolts (mV) to 220 millivolts (mV), and in the upper right pixel, the voltage on the power supply side rises from 140 millivolts (mV) to 240 millivolts (mV). As a result, the gate-source voltages for respective pixels are substantially the same as each other, and as a result, the variation in the drain-source current I_{ds} is suppressed.

As illustrated in FIGS. 9 and 10, by sampling and holding the bias voltage VB in the capacitive element 318, it is possible to suppress variation in the drain-source current Ids. For this reason, the current value of the reference current can be adjusted to a minimum value necessary for driving, and power consumption can be reduced as compared with the comparative example.

FIG. 11 is a diagram illustrating an example of a layout of the sample-and-hold switch 319, the capacitive element 318, and the current source transistor 317 according to the first embodiment of the present technology. As the sample-and-hold switch 319, for example, a MOS transistor is used. The gate of the transistor is connected to a signal line for supplying a control signal SH, and the source is connected to a signal line for supplying a bias voltage VB. In the drawing, “G”, “D”, and “S” represent the gate, the drain, and the source of the MOS transistor.

Furthermore, as the capacitive element 318, for example, a gate capacitance of the MOS transistor is used. The drain and the source of the transistor are connected to a node of a ground voltage VSS, and the gate is connected to the signal line for supplying the bias voltage VB.

Furthermore, the gate of the current source transistor 317 is connected to a connection node between the sample-and-hold switch 319 and the capacitive element 318, and the source is connected to the node of the ground voltage VSS.

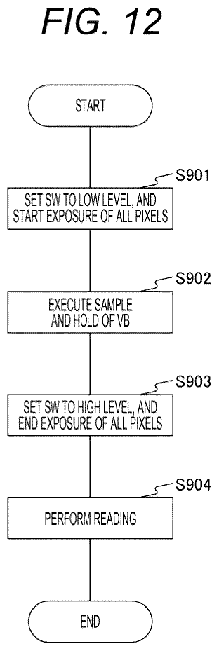

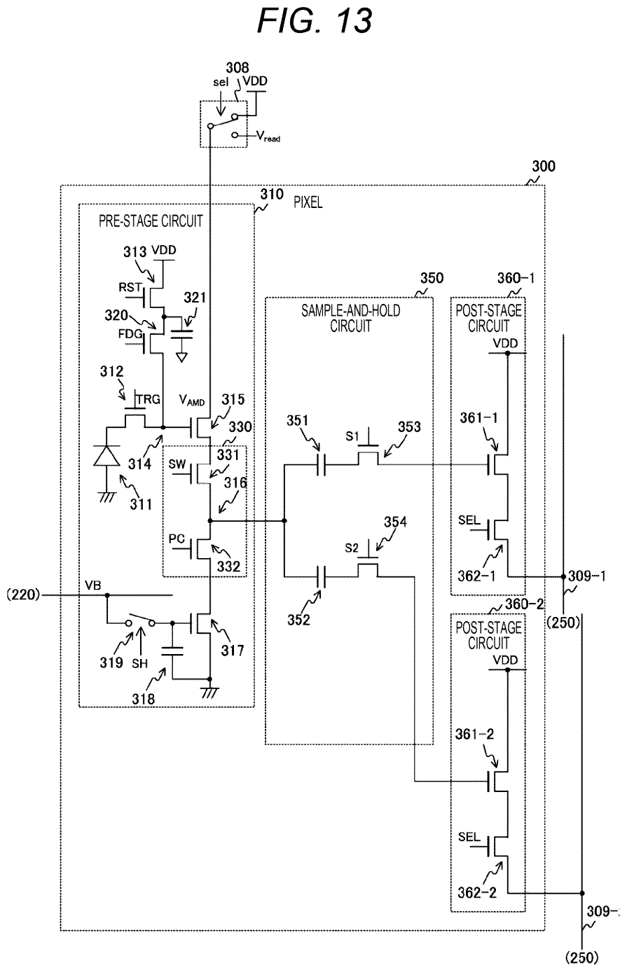

FIG. 12 is a flowchart illustrating an example of operation of the solid-state imaging element 200 according to the first embodiment of the present technology. The operation is started, for example, when a predetermined application for capturing image data is executed.

The vertical scanning circuit 211 causes exposure of all the pixels to be started in a state where the control signals SW of all the pixels are set to the low level (step S901). Then, the vertical scanning circuit 211 controls the sample-and-hold switches 319 of all the pixels to cause the sample and hold of the bias voltage VB to be executed while keeping the control signal SW at the low level (step S902). Then, the vertical scanning circuit 211 sets the control signal SW of all the pixels to the high level and causes the exposure of all the pixels to be ended (step S903). Subsequently, the solid-state imaging element 200 sequentially performs reading for all rows (step S904). After step S904, the solid-state imaging element 200 ends the operation for imaging.

As described above, according to the first embodiment of the present technology, since the sample-and-hold switch 319 samples and holds the bias voltage VB in the capacitive element 318 while the drain-source current is stopped, it is possible to suppress the variation in the gate-source voltage. As a result, it is possible to suppress the variation in the drain-source current for each pixel.

### Modification Example

In the above-described first embodiment, the pixels 300 having the circuit configuration illustrated in FIG. 3 are arranged, but the circuit configuration of the pixels 300 is not limited to that illustrated in FIG. 3. The solid-state imaging element 200 according to a modification example of the first embodiment is different from the solid-state imaging element 200 of the first embodiment in that a circuit configuration different from that in FIG. 3 is used.

FIG. 13 is a circuit diagram illustrating a configuration example of the pixel 300 according to the modification example of the first embodiment of the present technology. The pixel 300 according to the modification example of the first embodiment is different from the pixel 300 of the first embodiment in that there are two systems of post-stage circuits.

Post-stage circuits 360-1 and 360-2 are disposed in the pixel 300, a post-stage amplification transistor 361-1 and a post-stage selection transistor 362-1 are disposed in the post-stage circuit 360-1, and the post-stage selection transistor 362-1 is connected to the vertical signal line 309-1. A post-stage amplification transistor 361-2 and a post-stage selection transistor 362-2 are disposed in the post-stage circuit 360-2, and the post-stage selection transistor 362-2 is connected to a vertical signal line 309-2. With the circuit configuration illustrated in the drawing, it is possible to suppress fluctuation in a level of a post-stage node.

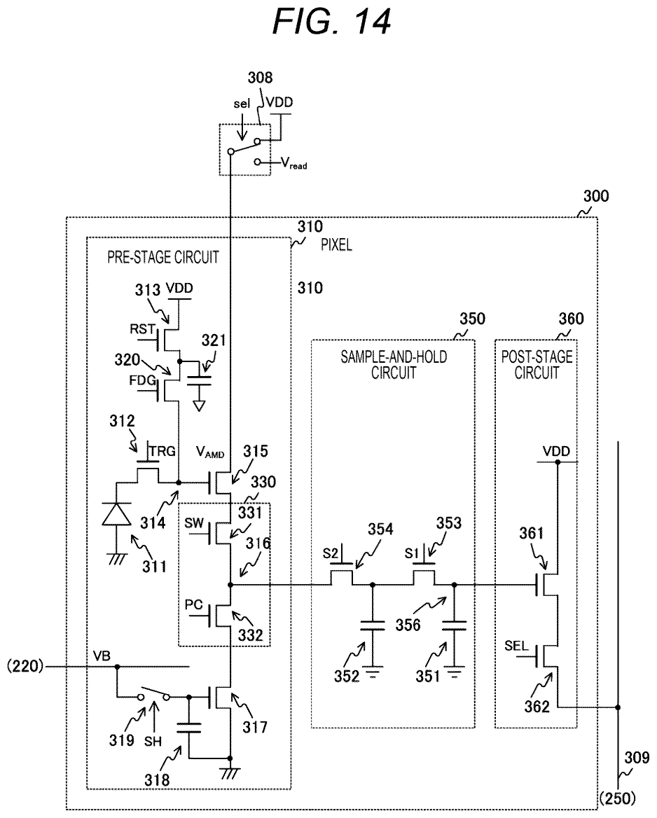

Note that, as illustrated in FIG. 14, the selection transistors 354 and 353 can be connected together in series between the pre-stage circuit 310 and the post-stage circuit 360. In this case, the capacitive element 351 is inserted between the post-stage node 356 and a ground node. The capacitive element 352 is inserted between a connection node between the selection transistors 354 and 353 and the ground node.

Regarding the circuit illustrated in the drawing, the control described in, for example, “Chen Xu et al., A Stacked Global-Shutter CMOS Imager with SC-Type Hybrid-GS Pixel and Self-Knee Point Calibration Single-Frame HDR and On-Chip Binarization Algorithm for Smart Vision Applications ISSCC2019.” can be referred to.

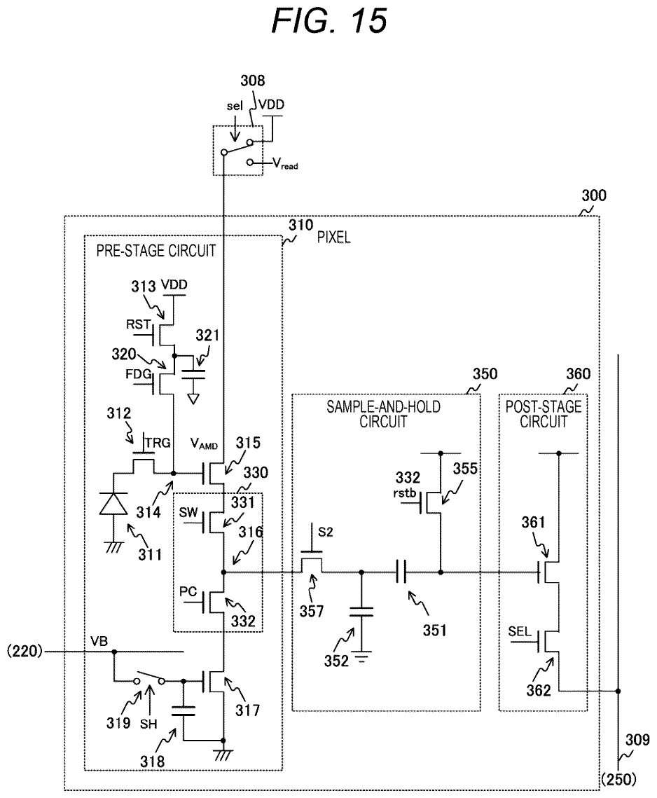

Furthermore, as illustrated in FIG. 15, a sampling transistor 357 can be disposed instead of the selection transistors 353 and 354 in the sample-and-hold circuit 350. In this case, the sampling transistor 357 and the capacitive element 351 are connected together in series between the pre-stage circuit 310 and the post-stage circuit 360. The capacitive element 352 is inserted between a connection node between the sampling transistor 357 and the capacitive element 351 and the ground node. The number of transistors can be reduced by the circuit configuration illustrated in the drawing.

Regarding the circuit illustrated in the drawing, the control described in, for example, “Jae-kyu Lee, et. al., A 2.1e-Temporal Noise and −105 dB Parasitic Light Sensitivity Backside-Illuminated 2.3 μm-Pixel Voltage-Domain Global Shutter CMOS Image Sensor Using High-Capacity DRAM Capacitor Technology, ISSCC 2020.” can be referred to.

As described above, according to the modification example of the first embodiment of the present technology, since there are two systems of post-stage circuits, it is possible to suppress the fluctuation in the level of the post-stage node.

### 2. Second Embodiment

In the above-described first embodiment, the circuits in the solid-state imaging element 200 are disposed on a single semiconductor chip, but in this configuration, there is a possibility that miniaturization of pixels is difficult. The solid-state imaging element 200 in a second embodiment is different from that in the first embodiment in that the solid-state imaging element 200 has a stacked structure.

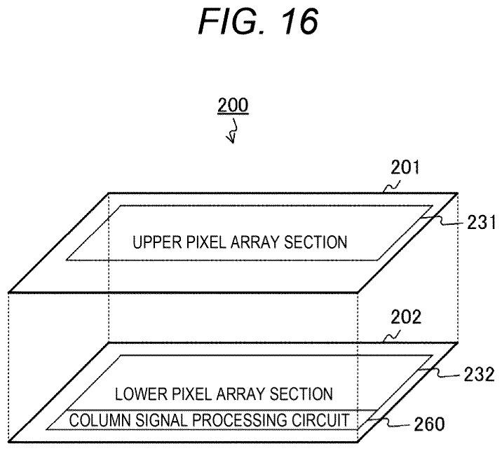

In FIG. 16, the solid-state imaging element 200 according to the second embodiment includes a lower chip 202 and an upper chip 201 stacked on the lower chip 202. These chips are electrically connected together by, for example, Cu—Cu bonding. Note that, in addition to the Cu—Cu bonding, the connection can be made using a via or a bump.

On the upper chip 201, an upper pixel array section 231 is disposed. On the lower chip 202, a lower pixel array section 232 and the column signal processing circuit 260 are disposed. For each pixel in the pixel array section 230, a part of the pixel is disposed in the upper pixel array section 231, and the rest is disposed in the lower pixel array section 232. Note that the upper chip 201 and the lower chip 202 are examples of a plurality of semiconductor chips described in the claims.

Furthermore, in the lower chip 202, the vertical scanning circuit 211, the timing control circuit 212, the DAC 213, and the load MOS circuit block 250 are also disposed. These circuits are not illustrated in the drawing.

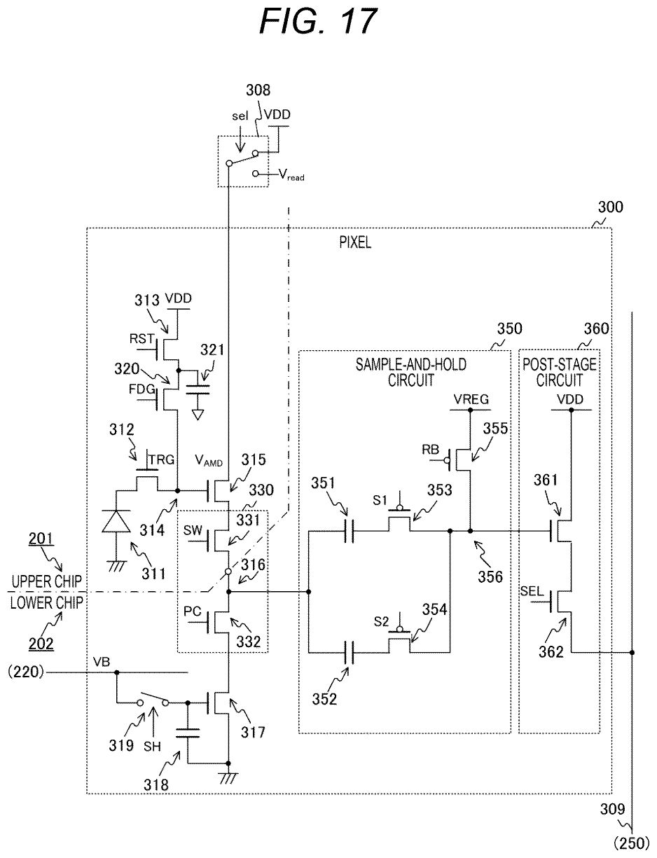

FIG. 17 is a circuit diagram illustrating a configuration example of the pixel 300 according to the second embodiment of the present technology. The elements in the pre-stage circuit 310 other than the precharge transistor 332, the current source transistor 317, the capacitive element 318, and the sample-and-hold switch 319 are disposed on the upper chip 201. The precharge transistor 332, the current source transistor 317, the capacitive element 318, the sample-and-hold switch 319, and the circuits after the sample-and-hold circuit 350 are disposed on the lower chip 202. As illustrated in the drawing, by dispersedly disposing the elements in the pixel 300 on the stacked upper chip 201 and lower chip 202, it is possible to reduce an area of the pixel, and miniaturization of the pixel is facilitated.

Note that elements and circuits can be dispersedly disposed on three or more stacked semiconductor chips.

As described above, according to the second embodiment of the present technology, since the circuits and elements in the pixel 300 are dispersedly disposed on the two semiconductor chips, miniaturization of the pixel is facilitated.

### 3. Third Embodiment

In the above-described first embodiment, the capacitive element 318 and the sample-and-hold switch 319 are disposed in the CIS, but these circuits can be disposed in a sensor other than the CIS. A third embodiment is different from the first embodiment in that the capacitive element 318 and the sample-and-hold switch 319 are disposed in an event-based vision sensor (EVS).

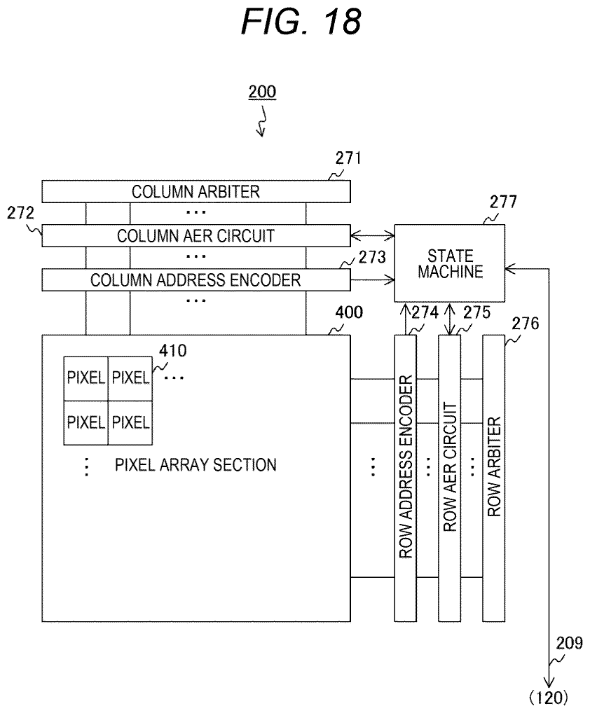

FIG. 18 is a block diagram illustrating a configuration example of the solid-state imaging element 200 according to the third embodiment of the present technology. The solid-state imaging element 200 is EVS, and includes a column arbiter 271, a column address event representation (AER) circuit 272, a column address encoder 273, a pixel array section 400, and a state machine 277. Furthermore, the solid-state imaging element 200 includes a row address encoder 274, a row AER circuit 275, and a row arbiter 276. Then, in the pixel array section 400, a plurality of pixels 410 is arranged in a two-dimensional grid pattern.

Each of pixels in the pixel array section 400 generates a differential signal indicating an amount of change in voltage according to a photocurrent, and Compares a level of the signal with a predetermined threshold value. A result of this comparison indicates an address event detection result. Here, the threshold value for comparison with the differential signal includes two mutually different threshold values, of which a larger one is defined as an upper limit threshold value and a smaller one is defined as a lower limit threshold value. Furthermore, an address event includes an ON event and an OFF event, and the detection result includes a 1-bit ON event detection result and a 1-bit OFF event detection result. The ON event is detected when the differential signal exceeds the upper limit threshold value, and the OFF event is detected when the differential signal falls below the lower limit threshold value.

Furthermore, the pixel 410 transmits and receives a request and a response (hereinafter, referred to as “handshake”) to and from the row AER circuit 275 when detecting an address event in order to externally output the address event detection result. Next, the pixel 410 performs a handshake with the column AER circuit 272.

The column arbiter 271 arbitrates the request from the column AER circuit 272 and transmits the response to the column AER circuit 272 on the basis of an arbitration result.

The column AER circuit 272 transmits and receives the request to require external output of the address event detection result and the response (performs the handshake) with each of the columns, the column arbiter 271, and the state machine 277.

The column address encoder 273 encodes an address of a column in which an address event occurs and transmits the address to the state machine 277.

The row address encoder 274 encodes an address of a row in which an address event occurs and transmits the address to the state machine 277.

The row arbiter 276 arbitrates a request from the row AER circuit 275 and transmits a response to the row AER circuit 275 on the basis of an arbitration result.

The row AER circuit 275 transmits and receives the request to require external output of the address event detection result and the response (performs the handshake) with each of the rows, the row arbiter 276, and the state machine 277.

The state machine 277 performs the handshake with the column AER circuit 272 and the row AER circuit 275. Upon receiving the request from the column AER circuit 272 and the row AER circuit 275, the state machine 277 decodes data from the column address encoder 273 and the IOW address encoder 274 to specify the address in which the address event is detected. Image data is generated by arranging of the address event detection results of the respective pixels in a two-dimensional grid pattern. The state machine 277 supplies the image data to the recording section 120.

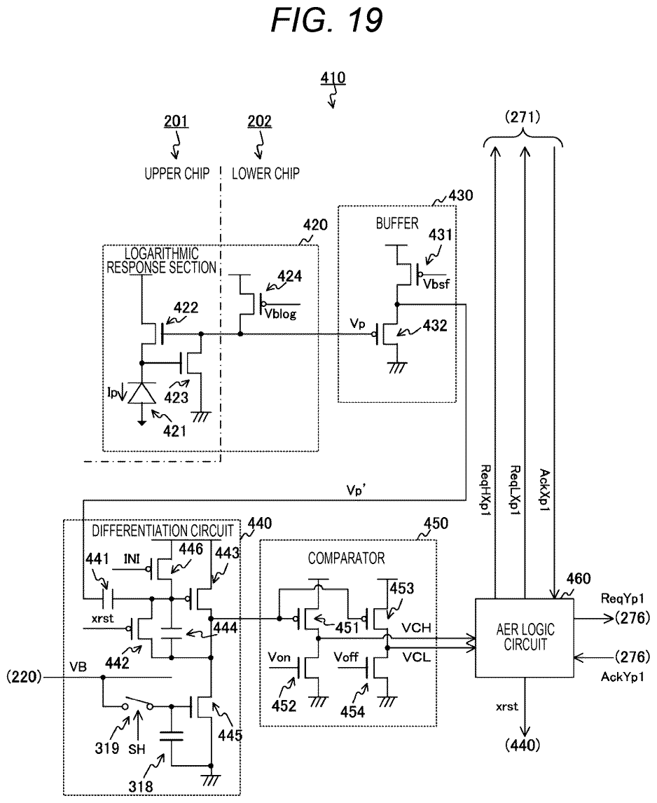

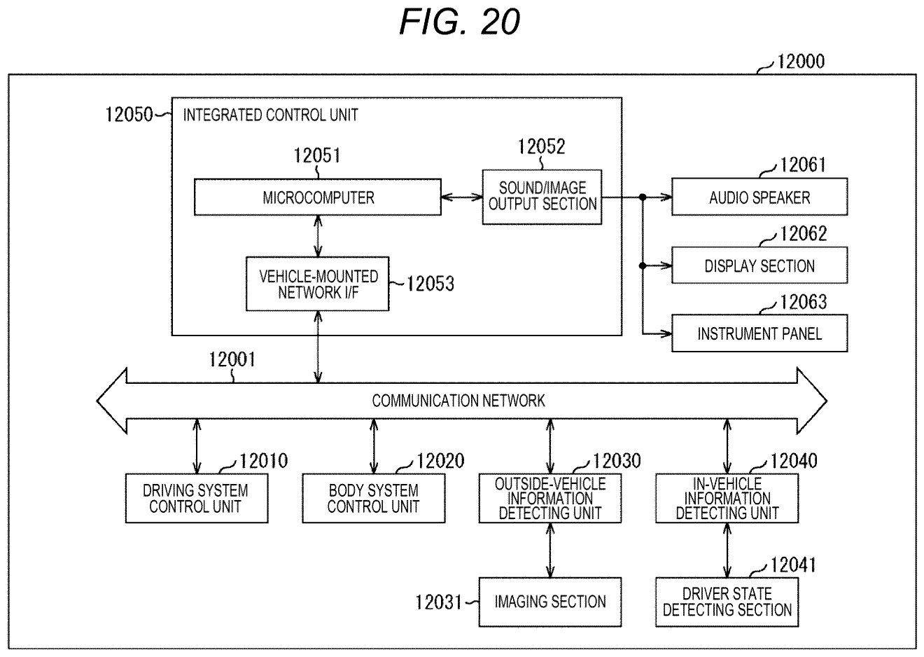

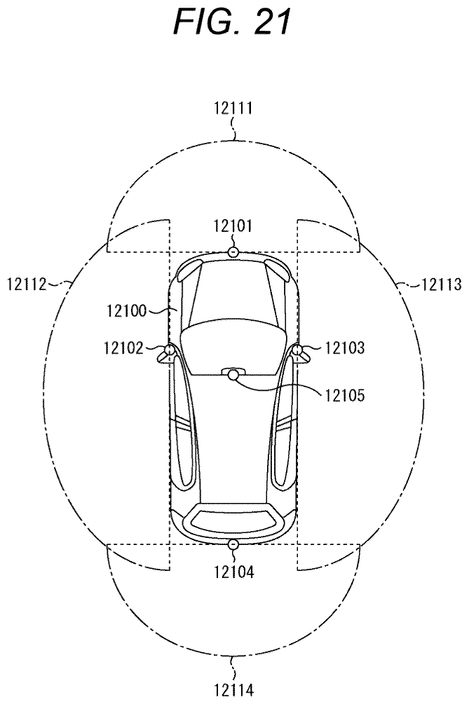

FIG. 19 is a circuit diagram illustrating a configuration example of the pixel 410 according to the third embodiment of the present technology. This pixel 410 includes a logarithmic response section 420, a buffer 430, a differentiation circuit 440, a comparator 450, and an AER logic circuit 460.

The logarithmic response section 420 includes a photoelectric conversion element 421, nMOS transistors 422 and 423, and a pMOS transistor 424.

The photoelectric conversion element 421 generates a photocurrent Ip as an electric signal by photoelectric conversion with respect to incident light.

The pMOS transistor 424 and the nMOS transistor 423 are connected together in series between a power supply and a ground terminal. Furthermore, the gate of the nMOS transistor 422 is connected to a connection node between the pMOS transistor 424 and the nMOS transistor 423, the source is connected to the photoelectric conversion element 421, and the drain is connected to the power supply. Then, a bias voltage Vblog is applied to the gate of the pMOS transistor 424. The gate of the nMOS transistor 423 is connected to a connection node between the nMOS transistor 422 and the photoelectric conversion element 421.

With the above-described circuit configuration, the logarithmic response section 420 performs current-voltage conversion on the photocurrent Ip to generate a pixel voltage Vp.

Furthermore, the solid-state imaging element 200 has a structure in which the upper chip 201 and the lower chip 202 are stacked, and the photoelectric conversion element 421 and the nMOS transistors 422 and 423 are disposed on the upper chip 201. On the other hand, the circuits after the pMOS transistor 424 are disposed on the lower chip 202.

Note that, although the solid-state imaging element 200 has a stacked structure, it is also possible to form a single semiconductor chip without having the stacked structure.

Furthermore, the buffer 430 includes pMOS transistors 431 and 432 connected together in series between the power supply and the ground node. The gate of the pMOS transistor 432 on the ground side is connected to the logarithmic response section 420, and a bias voltage Vbsf is applied to the gate of the pMOS transistor 431 on the power supply side. Furthermore, a connection point between the pMOS transistors 431 and 432 is connected to the differentiation circuit 440. By this connection, impedance transformation with respect to the pixel voltage Vp is performed, and a signal of the voltage after the transformation is output to the differentiation circuit 440 as an output signal Vp′.

The differentiation circuit 440 includes capacitive elements 318, 441, and 444, pMOS transistors 442, 443, and 446, an nMOS transistor 445, and the sample-and-hold switch 319.

One end of the capacitive element 441 is connected to the buffer 430, and the other end is connected to one end of the capacitive element 444 and the gate of the pMOS transistor 443. A reset signal xrst is input to the gate of the pMOS transistor 442, and the source and the drain are connected to both ends of the capacitive element 444. The pMOS transistor 443 and the nMOS transistor 445 are connected together in series between the power supply and the ground terminal. Furthermore, the other end of the capacitive element 444 is connected to a connection point between the pMOS transistor 443 and the nMOS transistor 445. The connection point is also connected to the comparator 450. Note that, the nMOS transistor 445 is an example of a current source transistor described in the claims.

The capacitive element 318 is inserted between the gate and the source of the nMOS transistor 445. The pMOS transistor 446 supplies a power supply voltage to the gate of the pMOS transistor 443 in accordance with an initialization signal INI, and turns off the pMOS transistor 443. Within a period in which the reset signal xrst is at the high level, the pMOS transistor 446 is regularly controlled to the off state by the initialization signal INI. For example, when the pMOS transistor 446 is turned off by the initialization signal INI and the current is cut off, the sample-and-hold switch 319 samples and holds the bias voltage VB in the capacitive element 318.

With such a connection, a differential signal indicating an amount of change in the output signal Vp′ is generated and output to the comparator 450. Furthermore, the differential signal is initialized by the reset signal xrst.

The comparator 450 includes pMOS transistors 451 and 453 and nMOS transistors 452 and 454. The pMOS transistor 451 and the nMOS transistor 452 are connected together in series between the power supply and the ground terminal, and the pMOS transistor 453 and the nMOS transistor 454 are also connected together in series between the power supply and the ground terminal. Furthermore, the gates of the pMOS transistors 451 and 453 are connected to the differentiation circuit 440. A predetermined upper limit threshold value Von is applied to the gate of the nMOS transistor 452, and a predetermined lower limit threshold value Voff is applied to the gate of the nMOS transistor 454.

A connection point between the pMOS transistor 451 and the nMOS transistor 452 is connected to the AER logic circuit 460, and a voltage at the connection point is output as a comparison result VCH. A connection point between the pMOS transistor 453 and the nMOS transistor 454 is also connected to the AER logic circuit 460, and a voltage at the connection point is output as a comparison result VCL. With such a connection, the comparator 450 outputs the comparison result VCH of the high level in a case where the differential signal exceeds the upper limit threshold value Von, and outputs the comparison result VCL of the low level in a case where the differential signal falls below the lower limit threshold value Voff. The comparison result VCH indicates an ON event detection result, and the comparison result VCL indicates an OFF event detection result.

Note that the comparator 450 detects both the ON event and the OFF event, but the comparator 450 may detect only one of the ON event and the OFF event. For example, when detecting only the ON event, only the corresponding pMOS transistor 451 and nMOS transistor 452 are disposed.

The AER logic circuit 460 performs a handshake on the basis of the comparison results VCH and VCL. The AER logic circuit 460 performs the handshake with the column arbiter 271 in a case where an address event occurs. Next, the AER logic circuit 460 performs a handshake with the row arbiter 276, and resets the differentiation circuit 440 with the reset signal xrst.

Note that, if a sensor is provided with a transistor as a current source for each pixel, the capacitive element 318 and the sample-and-hold switch 319 can be disposed in the sensor other than the EVS or the CIS. For example, the capacitive element 318 and the sample-and-hold switch 319 can be disposed in a sensor that performs photon counting using a SPAD.

As described above, according to the fourth embodiment of the present technology, since the capacitive element 318 and the sample-and-hold switch 319 are disposed in the EVS, it is possible to suppress variation in current in the EVS.

### 5. Example of Application to Mobile Body

The technology according to the present disclosure (present technology) can be applied to various products. For example, the technology according to the present disclosure may be implemented as a device to be mounted on a mobile body of any kind, such as an automobile, an electric automobile, a hybrid electric automobile, a motorcycle, a bicycle, a personal mobility, an airplane, a drone, a ship, or a robot.

FIG. 22 is a block diagram illustrating a schematic configuration example of a vehicle control system that is an example of a mobile body control system to which the technology according to the present disclosure can be applied.

The vehicle control system 12000 includes a plurality of electronic control units connected to each other via a communication network 12001. In the example illustrated in FIG. 22, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and a vehicle-mounted network interface (I/F) 12053 are illustrated as functional components of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 can output a control command to the body system control unit 12020, on the basis of the information about the outside of the vehicle obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example in FIG. 22, an audio speaker 12061, a display section 12062, and an instrument panel 12063 are illustrated as output devices. The display section 12062 may, for example, include at least one of an on-board display and a head-up display.

FIG. 23 is a diagram illustrating an example of an installation position of the imaging section 12031.

In FIG. 23, imaging sections 12101, 12102, 12103, 12104, and 12105 are included as the imaging section 12031.

The imaging sections 12101, 12102, 12103, 12104, and 12105 are provided, for example, at positions such as a front nose, a sideview mirror, a rear bumper, a back door, and an upper portion of a windshield in the interior of the vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly images of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 23 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

In the above, an example has been described of the vehicle control system to which the technology according to the present disclosure can be applied. The technology according to the present disclosure can be applied to, for example, the imaging section 12031 among the components described above. Specifically, for example, the imaging device 100 in FIG. 1 can be applied to the imaging section 12031. By applying the technology according to the present disclosure to the imaging section 12031, it is possible to suppress variation in current and reduce power consumption.

Note that the above-described embodiments show examples for embodying the present technology, and the respective matters in the embodiments and the respective matters specifying the invention in the claims have correspondence relationships. Similarly, the matters specifying the invention in the claims and the matters with the same names in the embodiments of the present technology have correspondence relationships, respectively. The present technology, however, is not limited to the embodiments, and can be implemented by making various modifications to the embodiments without departing from the scope of the present technology.

Note that the effects described herein are merely illustrative and not limiting, and other effects may also be present.

Note that the present technology may also have the following configurations.

(1) A solid-state imaging element including a plurality of pixels each provided with:
a current source transistor whose source is connected to a ground node and that supplies a predetermined drain-source current;
a capacitive element inserted between a gate of the current source transistor and the ground node; and
a sample-and-hold switch configured to sample and hold a predetermined bias voltage in the capacitive element within a period in which the drain-source current is not supplied.

(2) The solid-state imaging element according to (1), further including:
an amplification transistor that amplifies a voltage of a floating diffusion layer and outputs the voltage amplified from a source; and
a switch circuit that opens and closes a path between the amplification transistor and the current source transistor, in which
the sample-and-hold switch samples and holds the bias voltage in the capacitive element within a period in which the switch circuit is in an open state.

(3) The solid-state imaging element according to (2), further including a sample-and-hold circuit that holds each of a signal level corresponding to an amount of exposure and a predetermined reset level.

(4) The solid-state imaging element according to (3), in which
the switch circuit includes at least one of:
a switch transistor that opens and closes a path between the source of the amplification transistor and a pre-stage node connected to the sample-and-hold circuit; or
a precharge transistor that opens and closes a path between the pre-stage node and a drain of the current source transistor.

(5) The solid-state imaging element according to any of (1) to (4), further including:
a mirror source transistor through which a predetermined reference current flows, in which
the sample-and-hold switch opens and closes a path between a gate and a drain of the mirror source transistor and the gate of the current source transistor.

(6) The solid-state imaging element according to any of (1) to (5), in which the current source transistor, the capacitive element, and the sample-and-hold switch are disposed on any of a plurality of semiconductor chips stacked.

(7) The solid-state imaging element according to any of (1) to (6), in which each of the plurality of pixels detects presence or absence of an address event.

(8) A photodetection device including:
a pixel of a plurality of pixels each provided with a current source transistor whose source is connected to a ground node and that supplies a predetermined drain-source current, a capacitive element inserted between a gate of the current source transistor and the ground node, and a sample-and-hold switch configured to sample and hold a predetermined bias voltage in the capacitive element within a period in which the drain-source current is not supplied; and
a signal processing circuit that processes a pixel signal from each of the plurality of pixels.

(9) A method for controlling a solid-state imaging element, including:
a procedure in which a current source transistor whose source is connected to a ground node supplies a predetermined drain-source current; and
a sample-and-hold procedure in which a predetermined bias voltage is sampled and held in a capacitive element inserted between a gate of the current source transistor and the ground node within a period in which the drain-source current does not flow.

### REFERENCE SIGNS LIST

100 Imaging device
110 Imaging lens
120 Recording section
130 Imaging control section
200 Solid-state imaging element
201 Upper chip
202 Lower chip
211 Vertical scanning circuit
212 Timing control circuit
213 DAC
220 Accessory
221 Reference current source
222 Mirror source transistor
230, 400 Pixel array section
231 Upper pixel array section
232 Lower pixel array section
250 Load MOS circuit block
251 Load MOS transistor
260 Column signal processing circuit
261 ADC
262 Digital signal processing section
271 Column arbiter
272 Column AER circuit
273 Column address encoder
274 Row address encoder
275 Row AER circuit
276 Row arbiter
277 State machine
300, 410 Pixel
308 Selector
310 Pre-stage circuit
311, 421 Photoelectric conversion element
312 Transfer transistor
313 Pre-stage reset transistor
314 FD
315 Pre-stage amplification transistor
316 Pre-stage node
317 Current source transistor
318, 321, 351, 352, 441, 444 Capacitive element
319 Sample-and-hold switch
320 Conversion efficiency control transistor
330 Switch circuit
331 Switch transistor
332 Precharge transistor
350 Sample-and-hold circuit
353, 354 Selection transistor
355 Post-stage reset transistor
356 Post-stage node
357 Sampling transistor
360, 360-1, 360-2 Post-stage circuit
361, 361-1, 361-2 Post-stage amplification transistor
362, 362-1, 362-2 Post-stage selection transistor
420 Logarithmic response section
422, 423, 445, 452, 454 nMOS transistor
424, 431, 432, 442, 443, 451, 453 pMOS transistor
430 Buffer
440 Differentiation circuit
450 Comparator
460 AER logic circuit
12031 Imaging section

1. A solid-state imaging element comprising a plurality of pixels each provided with:
a current source transistor whose source is connected to a ground node and that supplies a predetermined drain-source current;
a capacitive element inserted between a gate of the current source transistor and the ground node; and
a sample-and-hold switch configured to sample and hold a predetermined bias voltage in the capacitive element within a period in which the drain-source current is not supplied.

2. The solid-state imaging element according to claim 1, further comprising:
an amplification transistor that amplifies a voltage of a floating diffusion layer and outputs the voltage amplified from a source; and
a switch circuit that opens and closes a path between the amplification transistor and the current source transistor, wherein
the sample-and-hold switch samples and holds the bias voltage in the capacitive element within a period in which the switch circuit is in an open state.

3. The solid-state imaging element according to claim 2, further comprising
a sample-and-hold circuit that holds each of a signal level corresponding to an amount of exposure and a predetermined reset level.

4. The solid-state imaging element according to claim 3, wherein
the switch circuit includes at least one of:
a switch transistor that opens and closes a path between the source of the amplification transistor and a pre-stage node connected to the sample-and-hold circuit; or
a precharge transistor that opens and closes a path between the pre-stage node and a drain of the current source transistor.

5. The solid-state imaging element according to claim 1, further comprising:
a mirror source transistor through which a predetermined reference current flows, wherein
the sample-and-hold switch opens and closes a path between a gate and a drain of the mirror source transistor and the gate of the current source transistor.

6. The solid-state imaging element according to claim 1, wherein the current source transistor, the capacitive element, and the sample-and-hold switch are disposed on any of a plurality of semiconductor chips stacked.

7. The solid-state imaging element according to claim 1, wherein each of the plurality of pixels detects presence or absence of an address event.

8. A photodetection device comprising:
a pixel of a plurality of pixels each provided with a current source transistor whose source is connected to a ground node and that supplies a predetermined drain-source current, a capacitive element inserted between a gate of the current source transistor and the ground node, and a sample-and-hold switch configured to sample and hold a predetermined bias voltage in the capacitive element within a period in which the drain-source current is not supplied; and
a signal processing circuit that processes a pixel signal from each of the plurality of pixels.

9. A method for controlling a solid-state imaging element, comprising:
a procedure in which a current source transistor whose source is connected to a ground node supplies a predetermined drain-source current; and
a sample-and-hold procedure in which a predetermined bias voltage is sampled and held in a capacitive element inserted between a gate of the current source transistor and the ground node within a period in which the drain-source current does not flow.
